(19) United States
(12) Patent Application Publication
(10) Pub. No.: US 2026/0253107 A1
(43) Pub. Date: Aug. 27, 2026

(54) AI-Based Predictive Analysis Engine for Beauty Trends

(71) Applicant: ELC MANAGEMENT LLC, Melville, NY (US)

(72) Inventor: Christopher Aidan, Austin, TX (US)

(21) Appl. No.: 19/642,050

(22) Filed: Apr. 8, 2026

Related U.S. Application Data
(62) Division of application No. 18/740,605, filed on Jun. 12, 2024.

(51) Int. Cl. G06Q 30/0241

(52) U.S. Cl. CPC G06Q 30/0276

(57) ABSTRACT

A method and device use generative AI to analyze media content, identify characteristics of beauty products or looks, and generate beauty content or product formulations based on these characteristics.

### CROSS-REFERENCE TO RELATED APPLICATIONS

This application is a divisional application divided from and claiming priority to U.S. Patent Application No. 18/740,605 entitled “AI-Based Predictive Analysis Engine for Beauty Trends,” filed on June 12, 2024, the entire contents of which is hereby expressly incorporated herein by reference.

### TECHNICAL FIELD

The present disclosure relates generally to methods and systems for utilizing generative artificial intelligence in the beauty industry, and more particularly, to techniques for generating beauty content and formulating new beauty products based on trends and characteristics identified in media content, such as generating beauty content that promotes specific characteristics of beauty products.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the rapidly evolving beauty industry, identifying and capitalizing on trends swiftly and effectively is a critical challenge. Traditional methods for tracking beauty trends often involve manual observation and analysis of social media content, sales data, and influencer activities, which can be time-consuming and may not always accurately capture the rapidly changing landscape. This delay in recognizing and responding to trends can result in missed opportunities for brands to connect with their target audience and leverage the trend to enhance their market presence. Furthermore, the process of matching existing products with current trends and creating relevant marketing content manually is resource-intensive and may not keep pace with the fast-moving beauty industry.

Additionally, the development of new beauty products in response to emerging trends poses its own set of challenges. The formulation of beauty products requires a delicate balance of ingredients to achieve desired effects, scent profiles, and chemical properties. The conventional approach to product development often involves a trial-and-error method which can be slow and inefficient, potentially delaying a brand’s entry into the market with a trending product. Moreover, ensuring that new products align with current trends while also meeting regulatory requirements and consumer expectations can be a complex process that necessitates extensive research and testing.

### SUMMARY

The increasing reliance on digital platforms and artificial intelligence technologies presents opportunities to overcome these challenges. By automating the process of trend identification, product matching, and content creation, there are possibilities for more efficient, accurate, and timely responses to emerging beauty trends. These advancements highlight the need for innovative platforms and technologies that can streamline these processes, thereby enabling brands to more effectively capitalize on beauty trends and meet consumer demands.

In one aspect, a method for implementing generative artificial intelligence to provide beauty content in accordance with beauty trends includes: (1) obtaining, by one or more processors, media content describing one or more beauty products or looks; (2) analyzing, by the one or more processors, the media content to identify one or more characteristics of the one or more beauty products or looks; (3) comparing, by the one or more processors, the one or more characteristics to a set of beauty products to identify at least one beauty product corresponding to the one or more characteristics; (4) applying, by the one or more processors, the at least one beauty product to a generative artificial intelligence (AI) model to generate beauty content associated with the at least one beauty product, wherein the generative AI model is trained on materials promoting products and characteristics of the products to learn a relationship between the materials and the characteristics; and (5) providing, by the one or more processors, the beauty content for display to a user.

In another aspect, a computing device for implementing generative artificial intelligence to provide beauty content in accordance with beauty trends includes: (1) one or more processors; and (2) a non-transitory computer-readable medium storing instructions thereon that, when executed by the one or more processors, cause the computing device to: (a) obtain media content describing one or more beauty products or looks; (b) analyze the media content to identify one or more characteristics of the one or more beauty products or looks; (c) compare the one or more characteristics to a set of beauty products to identify at least one beauty product corresponding to the one or more characteristics; (d) apply the at least one beauty product to a generative artificial intelligence (AI) model to generate beauty content associated with the at least one beauty product, wherein the generative AI model is trained on materials promoting products and characteristics of the products to learn a relationship between the materials and the characteristics; and (e) provide the beauty content for display to a user.

In yet another aspect, a method for generating a formulation of a new beauty product using generative artificial intelligence includes: (1) obtaining, by one or more processors, media content describing one or more beauty products; (2) analyzing, by the one or more processors, the media content to identify one or more ingredients of the one or more beauty products; (3) applying, by the one or more processors, the one or more ingredients to a generative artificial intelligence (AI) model to generate a formulation of a new beauty product that includes the one or more ingredients, wherein the generative AI model is trained on existing beauty products and corresponding ingredients of the existing beauty products to learn a relationship between the existing beauty products and the corresponding ingredients; and (4) creating the new beauty product using the generated formulation.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 describes a computing environment for implementing generative artificial intelligence to provide beauty content in accordance with beauty trends, according to some aspects.

FIG. 2 depicts a screenshot of example social media content featuring a person showing a trending makeup look, according to some aspects.

FIG. 3 depicts a combined block and logic diagram for training and using a generative AI model to generate beauty content and create formulations for new beauty products, according to some aspects.

FIG. 4 depicts a screenshot of example beauty content generated by the generative AI model to promote beauty products made by a particular organization which are associated with a beauty trend, according to some aspects.

FIG. 5 depicts a computer-implemented method for implementing generative artificial intelligence to provide beauty content in accordance with beauty trends, according to some aspects.

FIG. 6 depicts a computer-implemented method for generating a formulation of a new beauty product using generative artificial intelligence, according to some aspects.

### DETAILED DESCRIPTION

The beauty industry is characterized by rapid changes and trends that can emerge and fade within a very short period. The ability to quickly identify and capitalize on these trends is crucial for beauty brands to remain competitive and relevant. A beauty content generation system that leverages advanced technologies such as generative artificial intelligence (AI) models, including Generative Adversarial Networks (GANs) and Large Language Models (LLMs), offers a novel approach to navigating this fast-paced environment. This system obtains and analyzes media content from various sources, including social media, to identify trending beauty products or looks. By analyzing popularity metrics such as views, likes, and the number of followers of the users posting about these products or looks, the system can determine what is currently trending in the beauty industry.

The present techniques introduce a method and computing device for leveraging generative artificial intelligence (AI) to create and provide beauty content that aligns with current beauty trends. This approach involves obtaining media content that describes various beauty products or looks, analyzing this content to identify specific characteristics of the beauty products or looks, and then applying these characteristics to a generative AI model. This model, which is trained on materials promoting products and the characteristics of these products, generates beauty content associated with at least one beauty product that corresponds to the identified characteristics. The generated beauty content is then made available for display to users, offering a dynamic and responsive way to engage with beauty trends.

One significant improvement offered by the present techniques is the enhancement of processing efficiency within computing devices. One significant improvement this system introduces is in processing efficiency. By automating the identification of trends through the analysis of social media content, the system reduces the time and resources required to manually track and analyze these trends. This efficiency extends to the generation of beauty content, where the system uses a generative adversarial network (GAN) trained on marketing materials and product characteristics to create promotional materials that align with the identified trends. This process not only speeds up content creation but also ensures that the content is highly relevant and tailored to current consumer interests.

Another improvement is the optimized usage of network resources. The present techniques enable the efficient gathering and analysis of media content from various sources, including social media platforms, by selectively obtaining posts, images, or videos that describe beauty products or looks with a popularity metric above a certain threshold. This selective approach ensures that only relevant content is processed, thereby minimizing unnecessary data transmission and reducing the load on network resources. Furthermore, by leveraging a GAN that includes a text encoder and an image encoder, the system efficiently associates text with images or videos, optimizing the way content is processed and generated.

Furthermore, the present techniques contribute to improved memory usage within computing devices. By applying identified beauty products or looks to a generative AI model to generate beauty content, the present techniques utilize a structured approach to content generation that leverages pre-trained models and encoded materials. This approach allows for the efficient storage and retrieval of data, as well as the dynamic generation of content without the need for storing large volumes of pre-generated content.

The generative AI model, including a text encoder and an image encoder, plays a pivotal role in associating text with images or videos and identifying salient visual features that correspond to the text descriptions of trending beauty products. This model facilitates the creation of beauty content that not only promotes specific characteristics of beauty products but also depicts looks that match those found in the media content, indicating how the products can be used to achieve these looks.

Moreover, the present techniques extend beyond content generation to the creation of new beauty products. By identifying trending ingredients and applying them to the generative AI model, the system can generate formulations for new beauty products that include these trending ingredients. This capability to create new products based on current trends underscores the adaptability and innovative potential of the present techniques.

In summary, the present techniques offer a comprehensive and efficient approach to generating beauty content and new beauty products that resonate with current trends. By leveraging generative AI, these techniques not only improve processing, network, and memory usage within computing devices but also provide a dynamic and responsive tool for engaging with the ever-evolving beauty industry. This approach not only enhances the ability of beauty brands to stay ahead of trends but also fosters innovation and creativity in product development.

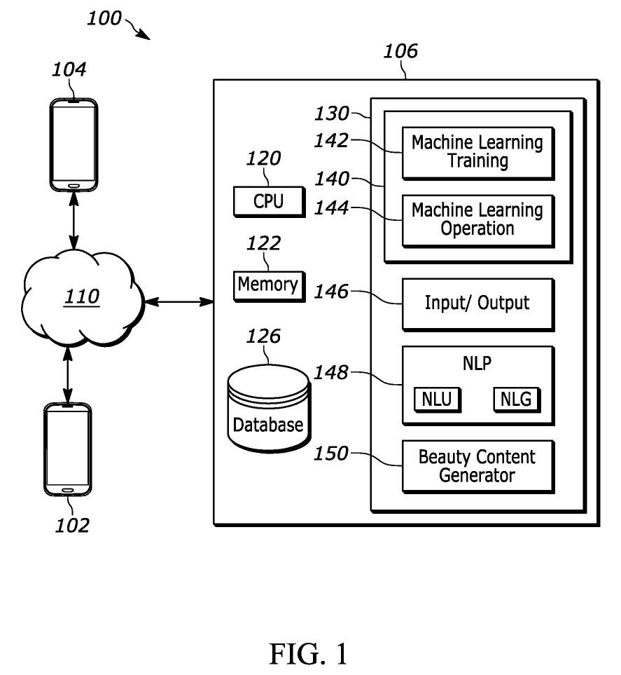

FIG. 1 illustrates an exemplary beauty content generation environment 100 associated with generating beauty content based on trending beauty products or looks. Although FIG. 1 depicts certain entities, components, equipment, and devices, it should be appreciated that additional or alternate entities, components, equipment, and devices are envisioned.

The environment 100 may include a user device 102, a content creator device 104, and a server 106. The user device 102, content creator device 104, and server 106 may be communicatively coupled via an electronic network 110.

As shown in FIG. 1, the environment 100 may include a user device 102 associated with a consumer interested in beauty trends. The consumer may be someone seeking to follow or recreate a trending beauty look or interested in purchasing beauty products. The user device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical components. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the beauty content generation environment 100 via the network 110.

The environment 100 may also include a content creator device 104. The content creator device 104 may be any suitable device for communication, including one or more computers, mobile devices, wearables, smart watches, smart contact lenses, smart glasses, augmented reality glasses, virtual reality headsets, mixed or extended reality glasses or headsets, telephones, and/or other electronic or electrical components. The content creator device 104 may communicate with other components of the beauty content generation environment 100 via the network 110.

In one aspect, one or more servers 106 may perform functionalities as part of a cloud network or may otherwise communicate with other hardware or software components within one or more cloud computing environments to send, retrieve, or otherwise analyze data or information described herein. For instance, in certain aspects of the present techniques, the beauty content generation environment 100 may comprise an on-premise computing environment, a multi-cloud computing environment, a public cloud computing environment, a private cloud computing environment, and/or a hybrid cloud computing environment. For example, an entity (e.g., a beauty brand) providing a platform to generate beauty content based on trends may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the beauty brand). Alternatively, or in addition, aspects of the public cloud may be hosted on-premise at a location owned/controlled by an enterprise generating the beauty content. The public cloud may be partitioned using virtualization and multi-tenancy techniques and may include one or more infrastructure-as-a-service (IaaS) and/or platform-as-a-service (PaaS) services.

A network 110 may comprise any suitable network or networks, including a local area network (LAN), wide area network (WAN), the Internet, or a combination thereof. For example, the network 110 may include a wireless cellular service (e.g., 4G, 5G, 6G, etc.). Generally, the network 110 enables bidirectional communication between the servers 106, a user device 102, and a content creator device 104. In one aspect, the network 110 may comprise a cellular base station, such as cell tower(s), communicating to the one or more components of the beauty content generation environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the beauty content generation environment 100 via wireless communications based upon any one or more of various wireless standards, including by non-limiting example, IEEE 802.11a/b/c/g (Wi-Fi), Bluetooth, and/or the like.

The server 106 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 122 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 122 via a computer bus to execute an operating system (OS) and/or computing instructions contained therein, and/or to access other services/aspects. For example, the processors 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine-readable instructions, methods, processes, elements, or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code, or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL-based database, such as MongoDB, or another suitable database. The database 126 may store data that is used to train and/or operate one or more ML models, provide augmented reality models/displays, among other things.

In one aspect, the computing modules 130 may include an ML module 140. The ML module 140 may include an ML training module (MLTM) 142 and/or an ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML-based algorithms may be included as a library or package executed on server(s) 106. For example, libraries may include the TensorFlow-based library, the HuggingFace library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function that maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization, and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 106 may include a client-server platform technology such as ASP.NET, Java J2EE, Ruby on Rails, Node.js, a web service or online API, responsible for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch-sensitive input panels, keys, buttons, lights, LEDs), which may be directly accessible via, or attached to, servers 106 or may be indirectly accessible via or attached to the user device 102. According to one aspect, an administrator or operator may access the servers 106 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU), and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more beauty content generators 150 which may be programmed to generate beauty content for beauty trends.

In some embodiments, the beauty content generator 150 discussed herein may be configured to utilize AI and/or ML techniques. The beauty content generator may employ supervised or unsupervised ML techniques, which may be followed by, and/or used in conjunction with, reinforced or reinforcement learning techniques. The beauty content generator 150 may employ the techniques utilized for ChatGPT or Google Bard.

Noted above, in some embodiments, a beauty content generator 150 may be configured to implement ML, such that server 106 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

In one embodiment, the beauty content generation environment may generate beauty content based upon trending beauty products or looks. In one aspect, the user device 102 or the content creator device 104 may transmit data describing trending beauty products or looks to the server 106. The server 106 may cause the beauty content generator 150 to generate beauty content for the consumer, which may be in an audio format, text format, and/or image format. The server 106 may provide the beauty content to the user device 102 or the content creator device 104 via network 110.

Although the beauty content generation environment 100 is shown to include one user device 102, one content creator device 104, one server 106, and one network 110, it should be understood that different numbers of user devices 102, content creator devices 104, servers 106, and/or networks 110 may be utilized.

The beauty content generation environment 100 may include additional, fewer, and/or alternate components, and may be configured to perform additional, fewer, or alternate actions, including components/actions described herein. Although the beauty content generation environment 100 is shown in FIG. 1 as including one instance of various components such as user device 102, content creator device 104, server 106, network 110, etc., various aspects include the beauty content generation environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the beauty content generation environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 106 and user device 102 may be connected via a direct communication link (not shown in FIG. 1) instead of, or in addition to, via network 110.

In operation, the computing environment 100 functions to streamline the process of generating beauty content in line with current beauty trends. A user, such as a beauty brand or marketer for a particular organization, may use the system to quickly identify trending beauty products or looks based on social media content. The system analyzes this content to identify trending characteristics and compares these to a database of beauty products made by the particular organization to find matches. It then applies these matches to a generative AI model, such as a GAN, to generate promotional or educational beauty content. This content can be tailored to promote the characteristics identified as trending, depict looks matching those found in the media content, and suggest products for creating these looks.

This computing environment allows beauty brands to rapidly respond to beauty trends, creating relevant and engaging content that aligns with current consumer interests. By leveraging generative AI models trained on extensive datasets of beauty products and promotional materials, the system can produce high-quality content that resonates with consumers, potentially driving sales and enhancing brand visibility in a highly competitive market.

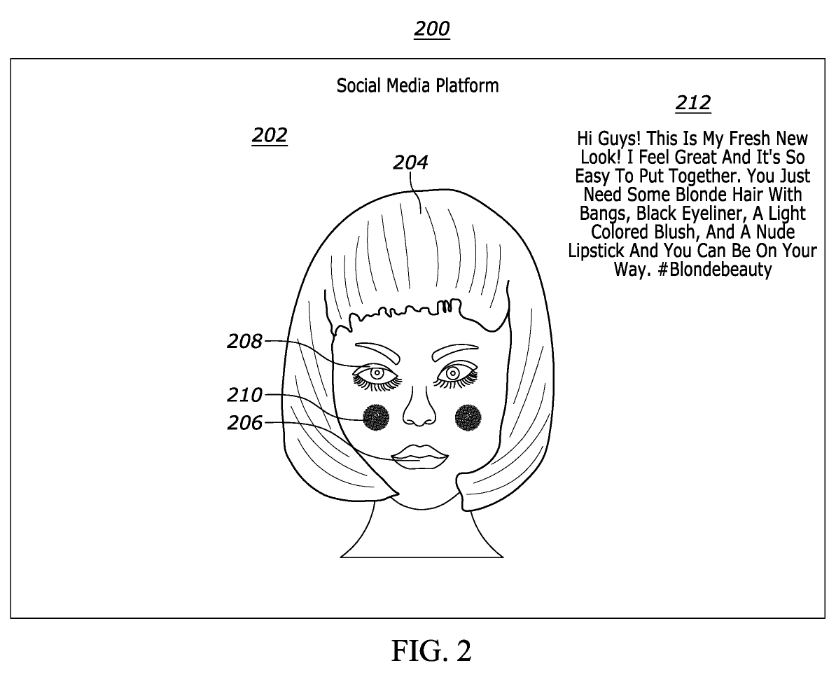

FIG. 2 illustrates an example screenshot of social media content 200 which may be obtained by the beauty content generation system and, more specifically, the server 106. The social media content 200 may include an image or video 202 of a trending beauty product or look. In the example shown in FIG. 2, the social media content includes an image of a person showcasing a specific makeup look that includes a unique hairstyle 204, a specific lipstick color 206, an eyeliner style 208, and a blush color 210. Additionally, the content 200 may include textual information 212 describing the beauty products or look, such as the brand of the lipstick, the shade of the eyeliner, or the hairstyle technique used.

To determine that a beauty product or look in the social media content 200 is trending, the server 106 obtains popularity metrics for the beauty product or look, such as views, likes, and the number of followers of the users posting about the beauty product or look. The server 106 compares the popularity metric(s) for a beauty product or look to a threshold popularity metric, and determines the beauty product or look is trending if the popularity metric(s) exceed the threshold. For example, if social media content about a particular beauty product or look has more than a threshold number of views or likes, the server 106 may determine that the beauty product or look is trending. Additionally, if the social media content is made by a user that has more than a threshold number of followers, the server 106 may determine that the beauty product or look is trending. Still further, if the combined social media images, videos, or posts about a particular beauty product or look has more than a threshold number of views or likes or the combined users making the posts, images, or videos have more than a threshold number of followers, the server 106 may determine that the beauty product or look is trending.

In response to identifying a beauty trend, the server 106 analyzes the social media content 200 to identify characteristics of the trending beauty product or look, such as the ingredients in the beauty product, the color of the lipstick 206, the style of the hairstyle 204, or the beneficial effect of the beauty product. The server 106 then compares these characteristics to a database or catalog of beauty products offered by a particular organization (e.g., a brand portfolio) to identify beauty products made by the particular organization that match the beauty trend.

Upon identifying matching beauty products, the beauty content generation system applies the identified products to a generative artificial intelligence (AI) model to generate beauty content associated with the identified products.

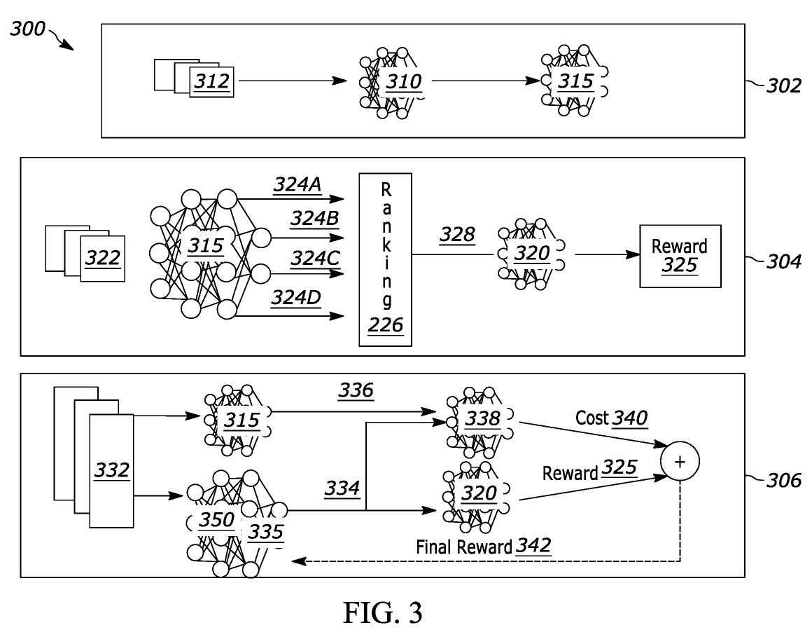

FIG. 3 depicts a combined block and logic diagram for training a generative AI model (e.g., a GAN) to generate beauty content, where the techniques described herein may be implemented according to some embodiments. Some blocks in FIG. 3 may represent hardware and/or software components, others may represent data structures or memory storing these data structures, registers, or state variables (e.g., data structures for beauty trends 312), and other blocks may represent output data (e.g., 325). Input and/or output signals may be represented by arrows labeled with corresponding signal names and/or other identifiers. The methods and systems may include one or more servers 302, 304, 306.

In some implementations, the beauty content may include text, such as a description of a trending beauty product, a description of how the trending beauty product can be used to create a particular look, a description of characteristics of the trending beauty product, such as a particular shade or color of the trending beauty product, ingredients in the beauty product, etc., or a reference to the social media content describing the trending beauty product (e.g., “#beautylicious”).

The system and methods to generate and/or train a generative AI model (e.g., via the ML module 140 of the server 106) may consist of three steps: (1) a Supervised Fine-Tuning (SFT) step where a pretrained language model (e.g., an LLM) may be fine-tuned on a relatively small amount of demonstration data curated by human labelers to learn a supervised policy (SFT ML model) which may generate outputs from a selected list of inputs. The SFT ML model may represent a cursory model for what may be later developed and/or configured as the generative AI model; (2) a reward model step where human labelers may rank numerous SFT ML model outputs to evaluate the outputs which best mimic preferred human outputs, thereby generating comparison data. The reward model may be trained on the comparison data; and/or (3) a policy optimization step in which the reward model may further fine-tune and improve the SFT ML model. The outcome of this step may be the generative AI model using an optimized policy. In one aspect, step one may take place only once, while steps two and three may be iterated continuously, e.g., more comparison data is collected on the current generative AI model, which may be used to optimize/update the reward model and/or further optimize/update the policy.

In one aspect, to generate the text, the server 302 may fine-tune a pretrained language model 310. The pretrained language model 310 may be obtained by the server 302 and be stored in a memory, such as memory 122 and/or database 126. The pretrained language model 310 may be loaded into an ML training module by the server 302 for retraining/fine-tuning. A supervised training dataset 312 may be used to fine-tune the pretrained language model 310 wherein each beauty trend input (e.g., beauty product or look) to the pretrained language model 310 may have a known beauty content output for the pretrained language model 210 to learn from. The supervised training dataset 312 may be stored in a memory of the server 302, e.g., the memory 122 or the database 126. In one aspect, the data labelers may create the supervised training dataset 312 having beauty trend inputs and appropriate beauty content outputs. In addition to including beauty products or looks as data inputs, the supervised training dataset 312 may also include characteristics of the beauty products or looks as data inputs, such as colors or shades of the beauty products, ingredients in the beauty products, etc. Still further, the supervised training dataset 312 may include social media content describing the beauty products or looks (“#truebeauty”).

The pretrained language model 310 may be fine-tuned using the supervised training dataset 312 resulting in the SFT ML model 315 which may provide appropriate beauty content outputs in response to beauty trend inputs once trained. The trained SFT ML model 315 may be stored in a memory of the server 302, e.g., memory 122 and/or database 126.

The beauty trend inputs and beauty content outputs may come from existing promotional, advertising, or marketing materials from the particular organization for beauty products or looks. The inputs may also come from existing social media content.

### Training The Reward Model

In one aspect, training the generative AI model 350 may include the server 304 training a reward model 320 to provide as an output a scaler value/reward 325. The reward model 320 may be required to leverage Reinforcement Learning with Human Feedback (RLHF) in which a model (e.g., generative AI model 350) learns to produce outputs which maximize its reward 335, and in doing so may provide beauty content outputs which are better aligned to beauty trend inputs.

Training the reward model 320 may include the server 304 providing a single beauty trend input 322 to the SFT ML model 315 as an input. The beauty trend input 322 may be provided via an input device (e.g., a keyboard) via the I/O module of the server, such as I/O module 146. The beauty trend input 322 may be previously unknown to the SFT ML model 315, e.g., the labelers may generate new beauty trend data, the beauty trend input 322 may include testing data stored on database 126, and/or any other suitable input data. The SFT ML model 315 may generate multiple, different beauty content outputs 324A, 324B, 324C, 324D to the beauty trend input 322. The server 304 may output the beauty content outputs 324A, 324B, 324C, 324D via an I/O module (e.g., I/O module 146) to a user interface device, such as a display (e.g., as text), a speaker (e.g., as audio), and/or any other suitable manner of output of the beauty content outputs 324A, 324B, 324C, 324D for review by the data labelers.

The data labelers may provide feedback via the server 304 on the beauty content outputs 324A, 324B, 324C, 324D when ranking 326 them from best to worst based upon the input-output pairs. The data labelers may rank 326 the beauty content outputs 324A, 324B, 324C, 324D by labeling the associated data. The ranked input-output pairs 328 may be used to train the reward model 320. In one aspect, the server 304 may load the reward model 220 via the ML module and train the reward model 320 using the ranked response pairs 328 as input. The reward model 320 may provide as an output the scalar reward 325.

In one aspect, the scalar reward 325 may include a value numerically representing a human preference for the best and/or most expected beauty content outputs for a beauty trend input, i.e., a higher scaler reward value may indicate the user is more likely to prefer that beauty content output, and a lower scalar reward may indicate that the user is less likely to prefer that beauty content output. For example, inputting the “winning” input-output pair data to the reward model 320 may generate a winning reward. Inputting a “losing” input-output pair data to the same reward model 320 may generate a losing reward. The reward model 320 and/or scalar reward 325 may be updated based upon labelers ranking 326 additional input-output pairs generated in response to additional beauty trend inputs 322.

In one example, a data labeler may provide to the SFT ML model 315 as a beauty trend input 322, “Look having bright red lipstick, fake eyelashes, and black mascara.” The input may be provided by the labeler via the user device 102 over network 110 to the server 304 utilizing the SFT ML model 315. The SFT ML model 315 may provide as output responses to the labeler via the user device 102: (i) “Try our Smith’s Red Lipstick with Smith Eyelashes and Smith Mascara” 324A; (ii) “To disrupt the trends, take out your #falsies and apply them with three coats of Smith Mascara. Then put on some of our Smith’s Red Lipstick and you’ll be ready for a night to remember. #beautytastic” 324B; and (iii) “Smith’s Red Lipstick can be combined with Smith Eyelashes and Smith Mascara for a fresh new look” 324C. The data labeler may rank 326, via labeling the input-output pairs, input-output pair 322/324B as the most preferred answer; input-output pair 222/324C as a less preferred answer; and input-output pair 222/324C as the least preferred answer. The labeler may rank 326 the input-output pair data in any suitable manner. The ranked input-output pairs 328 may be provided to the reward model 320 to generate the scalar reward 325.

While the reward model 320 may provide the scalar reward 325 as an output, the reward model 320 may not generate a beauty content output (e.g., text). Rather, the scalar reward 325 may be used by a version of the SFT ML model 315 to generate more accurate beauty content outputs for beauty trend inputs, i.e., the SFT model 315 may generate the beauty content output such as text for a beauty trend input, and the reward model 320 may receive the beauty content output to generate a scalar reward 325 of how well humans perceive it. Reinforcement learning may optimize the SFT model 315 with respect to the reward model 320 which may realize the configured generative AI model 350.

### RLHF to Train The Generative AI Model

In one aspect, the server 306 may train the generative AI model 350 to generate a beauty content output 334 to a random, new and/or previously unknown beauty trend input 332. To generate the beauty content output 334, the generative AI model 350 may use a policy 335 (e.g., algorithm) which it learns during training of the reward model 320, and in doing so may advance from the SFT model 315 to the generative AI model 350. The policy 335 may represent a strategy that the generative AI model 350 learns to maximize its reward 325. As discussed herein, based upon input-output pairs, a human labeler may continuously provide feedback to assist in determining how well the generative AI model’s 350 beauty content outputs match expected beauty content outputs to determine rewards 325. The rewards 325 may feed back into the generative AI model 350 to evolve the policy 335. Thus, the policy 335 may adjust the parameters of the generative AI model 350 based upon the rewards 325 it receives for generating good responses. The policy 335 may update as the generative AI model 350 provides beauty content outputs 334 to additional beauty trend inputs 332.

In one aspect, the beauty content output 334 of the generative AI model 350 using the policy 335 based upon the reward 325 may be compared using a cost function 338 to the SFT ML model 315 (which may not use a policy) beauty content output 336 of the same beauty trend input 332. The server 306 may compute a cost 340 based upon the cost function 338 of the beauty content outputs 334, 336. The cost 340 may reduce the distance between the beauty content outputs 334, 336, i.e., a statistical distance measuring how one probability distribution is different from a second, in one aspect the beauty content output 334 of the generative AI model 350 versus the beauty content output 336 of the SFT model 315. Using the cost 340 to reduce the distance between the beauty content outputs 334, 336 may avoid a server over-optimizing the reward model 320 and deviating too drastically from the human-intended/preferred beauty content output. Without the cost 340, the generative AI model 350 optimizations may result in generating beauty content outputs 334 which are unreasonable but may still result in the reward model 320 outputting a high reward 325.

In one aspect, the beauty content outputs 334 of the generative AI model 350 using the current policy 335 may be passed by the server 306 to the rewards model 320, which may return the scalar reward or discount 325. The generative AI model 350 beauty content output 334 may be compared via cost function 338 to the SFT ML model 315 beauty content output 336 by the server 306 to compute the cost 340. The server 306 may generate a final reward 342 which may include the scalar reward 325 offset and/or which may be restricted by the cost 340. The final reward or discount 342 may be provided by the server 306 to the generative AI model 350 and may update the policy 335, which in turn may improve the functionality of the generative AI model 350.

To optimize the generative AI model 350 over time, RLHF via the human labeler feedback may continue ranking 326 output of the generative AI model 350 versus outputs of earlier/other versions of the SFT ML model 315, i.e., providing positive or negative rewards or adjustments 325. The RLHF may allow the servers (e.g., servers 304, 306) to continue iteratively updating the reward model 320 and/or the policy 335. As a result, the generative AI model 350 may be retrained and/or fine-tuned based upon the human feedback via the RLHF process, and throughout continuing conversations may become increasingly efficient.

Although multiple servers 302, 304, 306 are depicted in the exemplary block and logic diagram 300, each providing one of the three steps of the overall generative AI model 350 training, fewer and/or additional servers may be utilized and/or may provide the one or more steps of the generative AI model 350 training. In one aspect, one server 106 may provide the entire generative AI model 350 training.

In addition to including text, the beauty content may include images or videos. For example, the beauty content may include digital advertisements or promotional videos. The generative AI model 350 may be trained to generate images or videos from text. For example, the generative AI model 350 may be trained using existing promotional, advertising, or marketing images or videos from the particular organization for beauty products or looks.

To generate images or videos as beauty content outputs from text inputs describing beauty trends, the generative AI model 350 may include a text encoder that associates text with images. The generative AI model 350 may also include an image encoder that associates salient visual features of those images with text.

More specifically, a set of images used to train the generative AI model 350 may be labeled with text, such as “cat” for an image of a cat, “dog” for an image of a dog, etc. Additionally, within each image, salient visual features may be labeled with a description of the salient visual feature. For example, an image may include a cat sitting on the lap of a man with sunglasses. The portion of the image depicting the cat may be labeled “cat,” the portion of the image depicting the man may be labeled “man,” the portion of image where cat is sitting may be labeled “man’s lap,” and the portion of the image depicting the man’s sunglasses may be labeled “sunglasses.”

When the text of the beauty trend input is provided/applied to the generative AI model, the text encoder in the generative AI model 350 may identify a subset of the images labeled with text that corresponds to the beauty trend input. Then within the subset, the image encoder within the generative AI model 350 may identify salient visual features of the images that correspond to the beauty trend input. The generative AI model 350 then combines the salient visual features of images within the subset in accordance with the text input describing the beauty trend to create the beauty content output.

For example, if the input is a look with red lipstick using Smith’s Red Lipstick and sunglasses, the generative AI model 350 may identify a first salient visual feature (e.g., a woman’s face with red lipstick in one image), a second salient visual feature (e.g., sunglasses in another image), and a third salient visual feature (e.g., Smith’s Red Lipstick in a third image). The generative AI model 350 may combine the salient visual features in the images to generate an image having a woman’s face in the center with sunglasses placed over her eyes and a Smith’s Red Lipstick container next to the woman. Similar to the generative AI model 350 for generating text outputs, the generative AI model 350 may use a reward model 320 and/or a cost function 338 and may use a policy 335 to maximize its reward 325. For example, each time the generative AI model 350 combines salient visual features to generate an image as a beauty content output, a human labeler may provide feedback regarding the quality of the beauty content output.

Additionally or alternatively, the generative AI model 350 may use a discriminator to compare the beauty content output to machine-generated beauty content and human-generated beauty content. The discriminator may determine whether the beauty content output is more like the machine-generated beauty content or the human-generated beauty content. If the discriminator determines that the beauty content output is more similar to the human-generated beauty content, the generative AI model 350 may determine the beauty content output is satisfactory and may present the beauty content output to a user. Otherwise, if the discriminator determines that the beauty content output is more similar to the machine-generated beauty content, the generative AI model 350 may combine the salient visual features in a different manner, select other salient visual features of images, or add additional or alternative imagery generate the beauty content output. The generative AI model 350 may provide the beauty content output to the discriminator again and repeat this process until the discriminator determines the beauty content output is more similar to the human-generated beauty content.

Still further, the beauty content may include any suitable combination of images, video, text, and audio. The generative AI model 350 may generate and combine images, video, text, and/or audio to create the beauty content.

In addition to creating beauty content, the generative AI model 350 may be trained to generate formulations of new beauty products based on ingredients in beauty trends. The generative AI model 350 may be trained using a supervised dataset of ingredients, types of beauty products (e.g., foundation, lipstick, mascara, eye liner, concealer, etc.), properties of the ingredients (e.g., beneficial effects, scents, chemical properties, acidity levels), and/or complementary properties of other ingredients as inputs. For each ingredient, the supervised dataset may include a set of existing beauty products that use the ingredient, and a list of ingredients and their respective amounts within each existing beauty product in the set. In this manner, the generative AI model 350 may be trained to generate formulations having certain ratios of each ingredient based on the ingredients and their respective ratios in existing beauty products.

For example, using the supervised dataset, the generative AI model 350 may “learn” that 90% of lipsticks include at least 5% of ingredient X. Thus, the generative AI model 350 may be likely to include ingredient X in a new lipstick formulation. In another example, using the supervised dataset, the generative AI model 350 may “learn” that foundations with Vitamin Y also typically include Vitamin Z. Therefore, the generative AI model 350 may include Vitamin Z in the foundation if the formulation includes Vitamin Y.

The generative AI model 350 also may be trained to identify properties of ingredients and identity other properties which are complementary to those properties in some way using the supervised dataset which includes the properties of ingredients and the complementary properties of other ingredients. For example, complementary properties may include an acid and a base to balance out the pH level of a product. In another example, complementary properties may include a pleasant odor for an ingredient that is mixed with an odorless ingredient. In yet another example, complementary properties may include two ingredients having similar beneficial effects, where the combination of the ingredients enhances the beneficial effects. For example, Vitamin X and Vitamin Y may have similar benefits but it may not be recommended for a consumer to have more than a certain amount of Vitamin X. Accordingly, the combination of Vitamin X and Vitamin Y may result in a larger beneficial effect without the harmful effects associated with too much of Vitamin X or Vitamin Y.

Training the generative AI model 350 may include the server 106 providing a single ingredient and a type of beauty product for the ingredient to the ML module 140 as an input. The ingredient may be previously unknown to the ML module 140. The ML module 140 may generate several formulations that include the ingredient for the particular type of beauty product. Each formulation may include a list of ingredients and their respective amounts within the beauty product. The ML module 140 may provide the formulations to a discriminator to compare each formulation to machine-generated formulations and formulations in existing beauty products. The discriminator may determine whether each formulation is more like the machine-generated formulations or the existing beauty product formulations and may provide a reward to each formulation accordingly. The ML module 140 then learns a policy based on the training with the discriminator to maximize the reward. The ML module 140 uses this policy to update the generative AI model 350 and generate new formulations.

To generate beauty content, a beauty trend input is provided to the trained generative AI model 350 that generates the beauty content (e.g., an image, text, video, audio, or any suitable combination of these) as an output. The beauty trend input may include an indication of the beauty product or look which is identified as trending according to the popularity metric(s). The beauty trend input may also include characteristics of the beauty trend, such as ingredients, colors, hairstyles, beneficial effects, scents, chemical properties, chemical compositions, or acidity levels of the beauty product(s) for the particular organization that match with the beauty trend. Additionally, the beauty trend input may include characteristics of the social media content used in displaying the beauty trend. For example, the social media content used to recommend a particular ingredient in blush may include a common hashtag or common reference, such as “#healthbeforebeauty.” The characteristics of the social media content may be provided to the generative AI model 350 to generate beauty content that includes the common hashtag or reference.

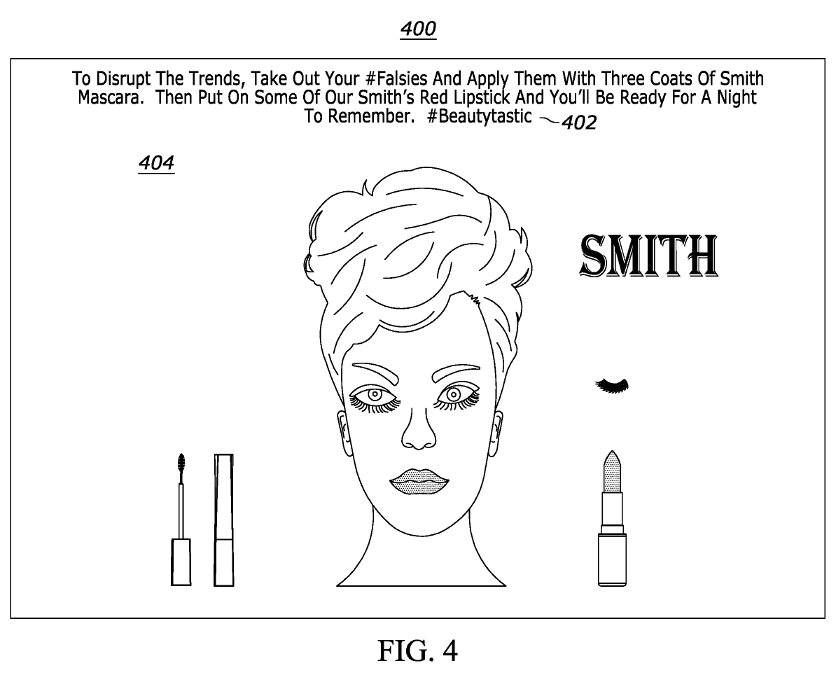

FIG. 4 illustrates an example screenshot 400 of beauty content generated by the generative AI model 350 of the beauty content generation system. For example, the beauty content may be provided for display on the content creator device 104 or a user device 102.

As shown in FIG. 4, the beauty content includes text 402 describing how trending beauty products can be used to create a particular look, and a reference to the social media content describing the trending look. The beauty content also includes an image 404 of a person showcasing the particular look that includes fake eyelashes, mascara, and red lipstick. The image 404 also depicts the trending beauty products made by the particular organization (Smith Mascara, Smith’s Red Lipstick, and Smith Fake Eyelashes).

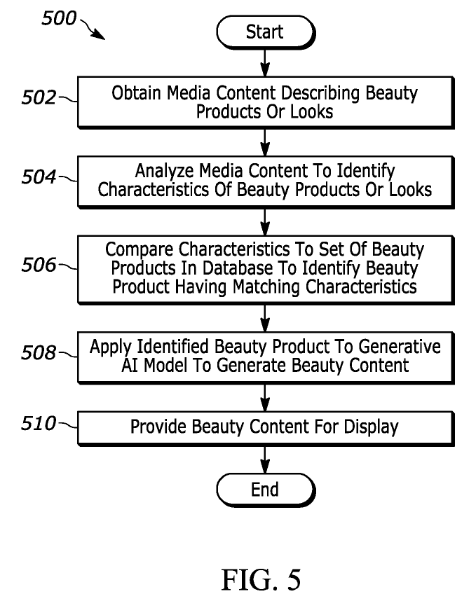

FIG. 5 depicts a computer-implemented method 500 for implementing generative artificial intelligence to provide beauty content in accordance with beauty trends. The method may be performed on a computing device equipped with one or more processors and a non-transitory computer-readable medium that stores instructions for performing the method, such as the server device 106.

The method 500 may include obtaining media content describing one or more beauty products or looks (block 502). The server 106 accesses and retrieves media content presented on the Internet (e.g., via social media platforms) that describes various beauty products or looks. This media content can be sourced from a variety of platforms, including but not limited to social media platforms where users and influencers frequently post images, videos, and descriptions of beauty products and looks.

For each beauty product or look in the media content, the server 106 obtains a popularity metric for the beauty product or look and compares the popularity metric to a popularity threshold to determine whether the beauty product or look is trending if the popularity metric exceeds the threshold.

If the popularity metric exceeds the threshold, the method includes analyzing the media content to identify one or more characteristics of the trending beauty product(s) or look(s) (block 504). The server 106 analyzes the content, extracting relevant characteristics such as ingredients, colors, hairstyles, beneficial effects, scents, chemical properties, compositions, or acidity levels of the beauty product(s), and/or characteristics of the social media content, such as hashtags, references, or descriptions in the social media content of the beauty products.

Next, the method involves comparing the identified characteristics to a set of beauty products associated with a particular organization to identify at least one beauty product corresponding to the identified characteristics (block 506). For example, the server 106 may access a database or catalog of beauty products provided by the particular organization, allowing it to match the characteristics extracted from the trending media content with beauty products that possess similar attributes.

The method further includes applying the at least one identified beauty product to a generative AI model to generate beauty content associated with the identified beauty product (block 508). The generative AI model, which is trained on materials promoting products and characteristics of the products, uses this training to learn a relationship between the materials and the characteristics. This step results in the creation of beauty content, such as advertisements or promotional materials, that highlights the identified beauty product and its trending characteristics. In some implementations, the method includes applying the at least one identified beauty product and the characteristics to the generative AI model to generate beauty content promoting the characteristics. For example, the characteristics may include ingredients, colors, hairstyles, beneficial effects, scents, chemical properties, chemical compositions, or acidity levels of the beauty product. In this manner, the beauty content may promote characteristics described in the media content, such as the beneficial effects of a particular trending ingredient or a trending color for a particular type of beauty product.

Finally, the method includes providing the generated beauty content for display to a user (block 510). The beauty content may be presented on a user interface, making it accessible to consumers or internally within an organization for further review or editing.

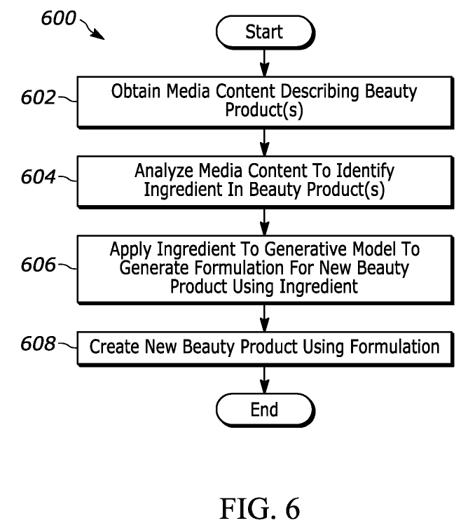

FIG. 6 depicts a computer-implemented method 600 for generating a formulation of a new beauty product using generative artificial intelligence (AI). The method 600 may be performed on a computing device that includes one or more processors and a non-transitory computer-readable medium that stores instructions for performing the method, such as the server device 106.

The method 600 begins with obtaining media content describing one or more beauty products (block 602). The server 106 accesses various sources of media content, such as social media platforms, where users or influencers may post images, videos, or descriptions of beauty products. The system analyzes this content to identify beauty products that are trending based on popularity metrics, such as the number of views, likes, or the influence level of the posting account.

Next, the method includes analyzing the obtained media content to identify one or more ingredients of a trending beauty product (block 604). In this step, the server 106 uses natural language processing (NLP) techniques and image recognition algorithms to extract information about the ingredients of the trending beauty products from the media content. This analysis may involve identifying textual or audio descriptions of ingredients within posts or recognizing visual representations of ingredients in images or videos. The identified ingredients reflect the characteristics of trending beauty products, such as their chemical composition, beneficial effects, or sensory properties like scent.

Following the identification of ingredients, the method involves applying the one or more ingredients to a generative AI model to generate a formulation of a new beauty product that includes the one or more ingredients (block 606). The generative AI model, trained on a database of existing beauty products and their ingredients, uses this training to understand the relationships between different ingredients and their effects. By applying the identified trending ingredients to this model, the system leverages generative AI to propose new beauty product formulations that incorporate these trending elements. The generative AI model may be further trained to identify properties of the one or more ingredients, identify a complementary property to the properties, and generate the formulation to include an additional ingredient to the one or more ingredients having the complementary property.

The generative AI model may also be trained on beneficial effects of the existing beauty products to learn a relationship between the existing beauty products, the corresponding ingredients, and the beneficial effects. Accordingly, the method may include applying the one or more ingredients and the beneficial effect of the one or more ingredients to the generative AI model to generate a formulation of the new beauty product that includes the one or more ingredients and the beneficial effect.

Finally, the method includes creating the new beauty product using the generated formulation (block 608). This step involves synthesizing the proposed formulation into a tangible beauty product. The generated formulation, which may specify a list of ingredients and their ratios, guides the production process to ensure that the new product aligns with the identified beauty trends. This creation process may be facilitated by a research and development (R&D) team within a beauty product organization, utilizing the formulation presented on a user interface to mix the ingredients in specified ratios and perform necessary testing to finalize the new product.

The computing environment in which the method 600 is executed may include various components, such as a server device hosting the generative AI model and a client device displaying the generated formulations to R&D team members. The server device, equipped with powerful processors and large storage capacities, is responsible for executing the intensive computational tasks involved in analyzing media content, running the generative AI model, and generating beauty product formulations. The client device, such as a desktop computer or tablet used by an R&D team member, provides an interface for reviewing and implementing the proposed formulations.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A method for generating a formulation of a new beauty product using generative artificial intelligence, the method comprising:
obtaining, by one or more processors, media content describing one or more beauty products;
analyzing, by the one or more processors, the media content to identify one or more ingredients of the one or more beauty products;
applying, by the one or more processors, the one or more ingredients to a generative artificial intelligence (AI) model to generate a formulation of a new beauty product that includes the one or more ingredients, wherein the generative AI model is trained on existing beauty products and corresponding ingredients of the existing beauty products to learn a relationship between the existing beauty products and the corresponding ingredients; and
creating the new beauty product using the generated formulation.

2. The method of claim 1, further comprising:
analyzing, by the one or more processors, the media content to identify a beneficial effect of the one more ingredients; and
applying, by the one or more processors, the one or more ingredients and the beneficial effect to the generative AI model to generate the formulation of the new beauty product that includes the one or more ingredients and the beneficial effect, wherein the generative AI model is further trained on beneficial effects of the existing beauty products to learn a relationship between the existing beauty products, the corresponding ingredients, and the beneficial effects.

3. The method of claim 1, wherein the generative AI model is further trained to:
identify one or more properties of the one or more ingredients;
identify a complementary property to the one or more properties; and
generate the formulation to include an additional ingredient to the one or more ingredients having the complementary property.

4. The method of claim 3, wherein the one or more properties includes at least one of a scent, a beneficial effect, or an acidity level.

5. The method of claim 1, wherein obtaining media content describing one or more beauty products includes:
obtaining, by the one or more processors, a plurality of posts, images, or videos on social media platforms each describing a beauty product; and
identifying, by the one or more processors, one or more beauty products described in the plurality of posts, images, or videos having a popularity metric above a popularity threshold.

6. The method of claim 1, wherein the formulation of the new beauty product includes a plurality of ingredients and a ratio for each of the plurality of ingredients indicating an amount of each ingredient to include in the new beauty product.

7. A computing device for generating a formulation of a new beauty product using generative artificial intelligence, the computing device comprising:
one or more processors; and
a non-transitory computer-readable medium storing instructions thereon that, when executed by the one or more processors, cause the computing device to:
obtain media content describing one or more beauty products;
analyze the media content to identify one or more ingredients of the one or more beauty products; and
apply the one or more ingredients to a generative artificial intelligence (AI) model to generate a formulation of a new beauty product that includes the one or more ingredients, wherein the generative AI model is trained on existing beauty products and corresponding ingredients of the existing beauty products to learn a relationship between the existing beauty products and the corresponding ingredients,
wherein the new beauty product is created using the generated formulation.

8. The computing device of claim 7, wherein the instructions further cause the computing device to:
analyze the media content to identify a beneficial effect of the one more ingredients; and
apply the one or more ingredients and the beneficial effect to the generative AI model to generate the formulation of the new beauty product that includes the one or more ingredients and the beneficial effect, wherein the generative AI model is further trained on beneficial effects of the existing beauty products to learn a relationship between the existing beauty products, the corresponding ingredients, and the beneficial effects.

9. The computing device of claim 7, wherein the generative AI model is further trained to:
identify one or more properties of the one or more ingredients;
identify a complementary property to the one or more properties; and
generate the formulation to include an additional ingredient to the one or more ingredients having the complementary property.

10. The computing device of claim 9, wherein the one or more properties includes at least one of a scent, a beneficial effect, or an acidity level.

11. The computing device of claim 7, wherein to obtain media content describing one or more beauty products, the instructions cause the computing device to:
obtain a plurality of posts, images, or videos on social media platforms each describing a beauty product; and
identify one or more beauty products described in the plurality of posts, images, or videos having a popularity metric above a popularity threshold.

12. The computing device of claim 7, wherein the formulation of the new beauty product includes a plurality of ingredients and a ratio for each of the plurality of ingredients indicating an amount of each ingredient to include in the new beauty product.

13. A non-transitory computer-readable medium storing instructions thereon that, when executed by one or more processors, cause the one or more processors to:
obtain media content describing one or more beauty products;
analyze the media content to identify one or more ingredients of the one or more beauty products; and
apply the one or more ingredients to a generative artificial intelligence (AI) model to generate a formulation of a new beauty product that includes the one or more ingredients, wherein the generative AI model is trained on existing beauty products and corresponding ingredients of the existing beauty products to learn a relationship between the existing beauty products and the corresponding ingredients,
wherein the new beauty product is created using the generated formulation.

14. The non-transitory computer-readable medium of claim 13, wherein the instructions further cause the one or more processors to:
analyze the media content to identify a beneficial effect of the one more ingredients; and
apply the one or more ingredients and the beneficial effect to the generative AI model to generate the formulation of the new beauty product that includes the one or more ingredients and the beneficial effect, wherein the generative AI model is further trained on beneficial effects of the existing beauty products to learn a relationship between the existing beauty products, the corresponding ingredients, and the beneficial effects.

15. The non-transitory computer-readable medium of claim 13, wherein the generative AI model is further trained to:
identify one or more properties of the one or more ingredients;
identify a complementary property to the one or more properties; and
generate the formulation to include an additional ingredient to the one or more ingredients having the complementary property.

16. The non-transitory computer-readable medium of claim 15, wherein the one or more properties includes at least one of a scent, a beneficial effect, or an acidity level.

17. The non-transitory computer-readable medium of claim 13, wherein to obtain media content describing one or more beauty products, the instructions cause the one or more processors to:
obtain a plurality of posts, images, or videos on social media platforms each describing a beauty product; and
identify one or more beauty products described in the plurality of posts, images, or videos having a popularity metric above a popularity threshold.

18. The non-transitory computer-readable medium of claim 13, wherein the formulation of the new beauty product includes a plurality of ingredients and a ratio for each of the plurality of ingredients indicating an amount of each ingredient to include in the new beauty product.
